(19) United States
(12) Patent Application Publication
(10) Pub. No.: US 2023/0350041 A1
(43) Pub. Date: Nov. 2, 2023

(54) Proximity Authentication Method

(71) Applicant: Everlink Limited, Greater London (GB)

(72) Inventors: Isaac Richard Colin Harmer, Durham (GB); Nathan Lewis Francis Kuruvilla, Greater London (GB); Jessica Grace Blakey, Greater London (GB)

(73) Assignee: Everlink Limited, Greater London (GB)

(21) Appl. No.: 18/021,937

(22) PCT Filed: Aug. 19, 2021
(86) PCT No.: PCT/GB2021/052155

§ 371 Date: Feb. 17, 2023

(30) Foreign Application Priority Data
Aug. 20, 2020 (GB) 2012996.1

(51) Int. Cl. H04W 12/63; H04W 12/06; G01S 11/14

(52) U.S. Cl. CPC G01S 11/14; H04W 12/06; H04W 12/63

(57) ABSTRACT

There is provided a method for authenticating the proximity of at least two devices, the method comprising: generating at least one packet; emitting at least one acoustic wave from at least one emitting device, each acoustic wave corresponding to a generated packet, at least one acoustic wave being emitted for all the generated packets, all the emitted acoustic waves forming an acoustic wave superposition. The superposition is received with at least one receiving device; assessing the similarity of the received superposition and a comparator; and authenticating proximity of each emitting device and each receiving device when the received superposition and the comparator fulfil a predetermined similarity requirement, wherein the comparator corresponds to a combination of all the generated packets.

### FIELD OF THE INVENTION

The present invention relates to a method for wirelessly authenticating the proximity of two or more devices. This typically uses sound to establish a signature match between the devices.

### BACKGROUND

As the number of devices communicating wirelessly increases globally, a range of situations now arise in day-to-day life that benefit from two or more devices being able to wirelessly authenticate that they are in proximity with each other.

Identifying when two devices are close to each other has become even more relevant in light of the Covid-19 pandemic, where some examples of such situations are contact-tracing between individuals. Other examples include checking into a reception area of a building; proving attendance at an event; or, when using a ride-hailing service, to authenticate that a user is entering a vehicle intended for them. Of course, various other scenarios are possible.

At present, there are a variety of techniques which attempt to wirelessly authenticate the proximity of wireless devices. Present attempts at wireless authentication include, the use of Bluetooth®, near field communication (NFC) chips or acoustic waves.

All current attempts to authenticate the proximity of devices suffer from deficiencies to an extent. Where Bluetooth® technology is employed, authentication may only be performed within a fixed wireless range of around 20 metres at most, characteristic of Bluetooth® connections. The users of the devices trying to authenticate are also required to pair the devices, which introduces inconvenience to the user. In addition, if a user wishes to authenticate via a Bluetooth® connection, they will first have to un-pair any existing peripherals, such as headphones, which are already connected via Bluetooth®. This makes the authentication process needlessly inconvenient. Furthermore, a device with Bluetooth® enabled consumes battery power at a much higher rate than a device with Bluetooth® disabled. This is not desirable as battery power is limited. Additionally, Bluetooth connections are not cross-platform. This means that, depending on the operating system of a device, a Bluetooth connection with another device running a different operating system may suffer from a number of issues that make the use of a Bluetooth connection undesirable. This tends to be due to configuration choices made by the operating system manufacturers. As an example, Android and Apple smartphones are typically not connectable with each other via Bluetooth.

Devices which use NFC chips similarly exhibit a series of shortcomings. To authenticate devices using an NFC method, the devices must be brought into proximity such that they are almost touching. This limits the ease with which a group of people could authenticate with a single device. In other words, NFC chips are used in extremely short range applications, which may not be desirable when authenticating devices. Additionally, NFC chips are limited to authentication between two devices at a time. This drawback prevents a group of devices from simultaneously authenticating proximity, and limits the number of scenarios where this type of authentication can be used. Furthermore, the use of NFC chips assumes that all devices possess the required hardware to be able to transmit and receive NFC signals. As such, devices without the required hardware are unable to authenticate proximity.

Some methods of device proximity authentication utilise acoustic waves to authenticate the proximity of two devices. These methods typically only allow for the authentication between two devices at a time, and authentication times are slow, taking at least 3 seconds, and sometimes as much as 6 seconds. This is due to the nature of the emitted signal since these signals rely on transmitting and receiving data, and the data is transferred in a binary format or a predetermined language translated into specific acoustic patterns. This contributes to the lack of speed of said methods since it takes a considerable length of time for enough data to pass through the emitted sound to be intelligible and actionable by a receiving device. Additionally, since the data needs translating into and out of an acoustic pattern when respectively transmitted and received, proximity authentication using acoustic waves requires high levels of processing power, draining power from the devices.

When authenticating proximity of devices, the complexity of the authentication must be high enough to lend confidence to the reliability of the authentication, yet fast enough that the users of the devices do not feel inconvenience and also while having minimal effect on the power usage of the devices. Currently, none of the above methods satisfactorily meet these requirements. At most, current authentication methods meet one of the requirements.

Each of the above methods of lack at least speed and reliability of authentication, as well as draining power. As such, there exists a need to reliably and quickly authenticate the proximity of wireless devices while using as little power as possible.

### SUMMARY OF INVENTION

According to an aspect, there is provided a method for authenticating the proximity of at least two devices, the method comprising: generating at least one packet; emitting at least one acoustic wave from at least one emitting device, each acoustic wave corresponding to a generated packet, at least one acoustic wave being emitted for all the generated packets, all the emitted acoustic waves forming an acoustic wave superposition; receiving, with at least one receiving device, the superposition; assessing the similarity of the received superposition and a comparator; and authenticating proximity of each emitting device and each receiving device when the received superposition and the comparator fulfil a predetermined similarity requirement, wherein the comparator corresponds to a combination of all the generated packets.

By authenticating the proximity of devices in this way, this method provides secure authentication due to the use of the superposition and comparator, and makes it possible to authenticate more than two devices at once. Further, since there is no data transfer, the processing power and processing time required to emit each acoustic waves and receive the superposition is limited, allowing the method to have a low impact on the battery of each receiving device and each emitting device. Also, by using sound, the distance over which proximity is able to be authenticated will generally be about the same as the range a user would consider as being in proximity of another user or location, while allowing a comfortable distance to be maintained between users or a user and a device. Overall, this means the method allows secure authentication of two or more devices, while minimising the impact on device battery life and working over user-friendly range.

As used herein, the term “superposition” is intended to mean the superposition of the emitted acoustic waves and any ambient environmental sound, but may simply mean a superposition of the emitted acoustic waves.

The emitted acoustic waves and formed superposition attain a level of complexity not achieved by existing technologies. In this context complexity refers to a large degree of variability and randomness in the features and characteristics of the acoustic waves and formed superposition.

The distance at which authentication is able to be performed is augmentable depending on the volume of the emitted acoustic waves and the environment in which the receiving device is located. For example, an emitting device could emit the acoustic wave at a relatively high volume to perform authentication at a distance of greater than 20 meters (m). Alternatively, the acoustic wave could be emitted at a lower volume to perform authentication at a shorter distance, for example 10 centimetres (cm).

Typically, each emitted acoustic wave may be emitted in a frequency range that is imperceptible to human hearing. This typically includes ultrasound waves. This may be considered to be sound waves with a frequency of above 15,000 Hertz (Hz).

The comparator may be a mathematically computed quantity which corresponds to the superposition in an expected way. This allows proximity authentication to be reliably achievable. The comparator is the expected value of the received acoustic superposition. In this sense, it is not a physically created quantity, but rather a mathematical quantity. To elaborate, the comparator may be formed by determining all of the acoustic waves that would be formed by the at least one packet, and then mathematically summing them or conducting some form of transformation or conversion on the at least one packet. When applying this approach, the acoustic waves are not emitted and then combined to form the comparator.

In some examples, each emitting device and each receiving device may be connectable to a network, each emitting device and each receiving device thereby being part of the network. This allows for information transfer between the devices in a non-acoustic manner, which assists the process of authentication. It is worth noting that the devices are described as being “connectable”, which is intended to indicate that an active connection between the devices is not always required. For example, a device may connect to a network to send and/or receive data and may then disconnect from the network, or the device may be connected to a telecommunications network allowing it to access a website and upload and/or download data from the website, the website providing a connection to the network.

Each generated packet may be generated in the network. In this way, each packet may be generated at separate locations or alternatively in a different part of the network from each emitting device. Advantageously, this reduces processing performed on the emitting device, thereby reducing battery consumption of the emitting device.

The received superposition and/or comparator may be transmitted within the network to an assessment module from a respective source. In this arrangement, the received superposition and/or comparator may be generated in different locations to where the assessment is carried out, thereby reducing processing performed in the receiving and emitting devices. Further, the speed with which the entire process is performed means that battery consumption of the receiving and emitting devices is reduced.

In some examples, when the assessment module determines that the superposition and the comparator do not fulfil a threshold similarity requirement, the assessment module does not authenticate proximity of the at least one emitting device to the at least one receiving device. This adds an additional level of confidence to the authentication method. Typically, if authentication is unsuccessful, the assessment module will discard the received superposition and the comparator and wait until further information is received. Alternatively, the assessment module may alert the emitting devices that authentication was not established. The assessment module may request additional information from the at least one receiving device and/or the emitting device. Alternatively, the assessment module may not alert the device that failed to authenticate that authentication has not been established.

Each emitted acoustic wave may include at least one configured primary characteristic, the configured primary characteristic being determined by the packet to which the respective acoustic wave corresponds. This solves the problem of limited complexity in the superposition. By configuring a primary characteristic of an acoustic wave, the chances of a malicious device replicating that acoustic wave in an attempt to falsely authenticate proximity are significantly reduced.

The configured primary characteristic may comprise at least one of: frequency, amplitude and duration. By configuring one or more of these characteristics, the predictability of the emitted acoustic wave is reduced. In this example, the term “configured primary characteristic” is intended to mean setting a primary characteristic to a certain value, or, in other words, to manipulate the acoustic wave into a particular form based on the packet to which the respective acoustic wave corresponds.

In an example, each configured primary characteristic is variable during emission of the respective acoustic wave. This allows for any of the primary characteristics to change while the acoustic wave is being emitted. For example, consider an acoustic wave which is emitted for a period of 1 second (s). When the emission begins, the device may emit the acoustic wave at a frequency of 16,000 Hz and an amplitude of 18 decibels (dB). After 0.5 s of emission, the frequency may be adjusted to 18,000 Hz, and the amplitude increased to 30 dB. These values are intended only as examples, other values are of course possible. These characteristics could be varied further, or could be maintained for the remaining duration of the emission. In this sense, the configured characteristics of the acoustic wave have been varied during emission. One of the configured characteristics may be varied during emission, or multiple characteristics may be varied. This further increases the complexity of the emitted acoustic wave, and the superposition.

Each received superposition may have at least one configured secondary characteristic. Secondary characteristics are another type of characteristic that may be used in addition to or instead of a primary characteristic. Much like a primary characteristic, a secondary characteristic adds a layer of complexity to the emitted acoustic wave and by extension the superposition. This allows for faster authentication and makes replication more difficult, thereby increasing security.

In an example, the configured secondary characteristic comprises at least one of: a complexity rating, a timestamp, a geostamp, ambient sound. Other secondary characteristics are possible, for example, the identity of a Wi-Fi network to which the emitting device is connected to. Such secondary characteristics further increase the complexity of the received superposition. Moreover, the timestamp can be used to account for Doppler effects, which may arise even when the user is moving at walking pace.

The received superposition may have at least one primary characteristic, the primary characteristic comprising at least one of frequency, amplitude and duration, and before the received superposition is assessed, the received superposition may be altered to remove at least one property of at least one primary characteristic. As used here, a “primary characteristic” is intended to be different to the “configured primary characteristic” mentioned previously. A “primary characteristic” is intended to refer to an intrinsic property of an acoustic wave, while a “configured primary characteristic” is intended to refer to a manipulation of said primary characteristic. The feature of removing a primary characteristic provides an additional layer of security to the authentication method, and prevents third-party devices, such as those that may be eavesdropping or those that accidentally overhear, from successfully gaining authentication since the received superposition at such third party devices will not have the primary characteristic removed when seeking authentication, which would be a flag that the third party device seeking authentication is a device that is intended to be seeking authentication.

As an example implementation of this feature, the received superposition may have a certain amplitude at a certain frequency, such as, the received superposition having an amplitude of 20 dB at 16,000 Hz. The received superposition may be altered after it is received to remove this amplitude at this frequency, or in a narrow frequency band around 16,000 Hz, by conducting processing on the received superposition. Subsequently, if, during the assessment, the superposition being assessed contains a non-zero amplitude at 16,000 Hz, it will be determinable that the superposition being assessed is not genuine and authentication may be refused. Another example is that a superposition may have a duration of 2 s when it is received, but this duration is then removed from the superposition. To be clear, this does not mean that the superposition collapses to a single instant in time, but rather that information detailing the duration of the superposition is not available when the superposition is being assessed. During assessment, if it is determined that a superposition includes a duration, authentication of the superposition will be rejected.

In an example, each acoustic wave emitted from an emitting device may be a first acoustic wave, the method may further comprise: emitting, by a receiving device, a second acoustic wave concurrently with each first acoustic wave, wherein all the first acoustic waves and second acoustic waves form the acoustic wave superposition; and removing each second acoustic wave from the received superposition before the received superposition is assessed. In this example, any eavesdropping devices would receive all of the first acoustic waves and all the second acoustic waves, but would be unaware that the second acoustic waves did not form part of the superposition to be assessed. In this sense, the second acoustic waves obfuscates the assessed superposition from an eavesdropping device. When a superposition which includes the second acoustic wave is assessed, authentication of that superposition will be rejected. This provides an extra layer of security to the authentication method. In this scenario there may be at least two receiving devices which each emit a second acoustic wave.

In some examples, the predetermined similarity requirement is 100%. By requiring that the comparator and the received superposition are exactly the same, that is, they exhibit 100% similarity, confidence in the authentication method is increased. Lower predetermined similarity requirements are also possible, and may be used if appropriate in the circumstances. For example, if the method is used to authenticate a payment, then 100% similarity is required between the superposition and the comparator. In this context, a payment could be an in-person, “peer-to-peer” payment, or alternatively, an online payment. In a Covid-19 contact-tracing scenario, a lower threshold, for example 90%, or 80% may be more appropriate as a precautionary measure to ensure that any devices which may reasonably be thought to be in proximity can be traced.

In some examples, the minimum frequency of each acoustic wave is 15 kHz. This features provides the advantage of making the acoustic waves inaudible to the vast majority of listeners, and reduces the interference of environmental sounds. Typically, the minimum frequency of each acoustic wave is 19.5 kHz. This ensures that the acoustic waves cannot be heard by listeners.

The maximum frequency of each acoustic wave may be 25 kHz. Most modern smartphone devices can emit sounds exceeding 25 kHz, so by choosing a maximum frequency of 25 kHz, the method can be performed by the vast majority of consumer devices without the need for expensive specialist equipment. Typically, the maximum frequency of each acoustic wave may be 21.5 kHz. This ensures that the acoustic waves be emitted over a suitably large range of frequencies.

In some examples, only a single packet is generated. This simplifies the comparison process by reducing the number of packet which must be combined to form the superposition and the comparator.

Alternatively, a plurality of packets may be generated. This feature allows for authentication to be performed without any interaction with the network. In other words, the authentication may be performed offline.

In some examples, there is only a single emitting device, and the single packet is generated at the single emitting device. This feature allows for the authentication method to be performed offline.

There may be a plurality of emitting devices, and each emitting device may generate at least one of the packets and emit the packets generated at the respective device as acoustic waves. This feature also allows for the authentication method to be performed offline.

In some examples, the at least one packet is generated remotely from each emitting device. In this scenario, “remotely” is intended to mean that the at least one packet is generated by a component in a network, such as a server or another device.

In some examples, the assessment and authentication is carried out at each receiving device. It is worth noting that to achieve this, the comparator would need be communicated to each of the receiving devices or to be generated at each receiving device. Carrying out the assessment and authentication at each receiving device allows multiple devices to be authenticated offline.

In some examples, the assessment and authentication is carried out remotely from each receiving device. As above, in this example, “remotely” is intended to mean that these steps are carried out by component in a network other than at each receiving device, such as at a server or other device. In this way, the processing time used by the receiving device is reduced, thereby reducing battery usage of the receiving device.

There may be a plurality of receiving devices, and at least one receiving device may also be an emitting device. Many consumer devices include components capable of emitting sound and/or components capable of receiving sound, such as a speaker and a microphone respectively. This makes it possible that a receiving device may also be an emitting device. This feature improves the versatility of the method according to the aspect by allowing a device to perform more than one function.

In some examples, at least one of the at least one of the emitting devices may also be a receiving device. Similar to the example where a receiving device may also be an emitting device, when at least one emitting device is also a receiving device, the versatility of the devices is increased.

In this example, the comparator may also be an acoustic wave superposition. This feature allows for a superposition to be compared against a superposition received at another device.

### BRIEF DESCRIPTION OF FIGURES

A proximity authentication method and various examples of applying the method are described in detail herein, with reference to the accompanying figures, in which:

FIG. 1 shows a flowchart for an example method for performing proximity authentication;

FIG. 2 shows an example of two devices authenticating proximity, where both devices act as emitting and receiving devices;

FIG. 3 shows an example of two devices authenticating, where two packets are generated remotely and transmitted from the server to the emitting devices

FIG. 4 shows an example of two devices authenticating proximity, where one device is an emitting device and the other device is a receiving device;

FIG. 5 shows an example of two devices authenticating proximity in an offline environment;

FIG. 6 shows an example of four devices authenticating proximity with each other;

FIG. 7 shows an example of two devices authenticating proximity, where a single packet is generated locally at emitting device; and

FIG. 8 shows an example of two devices authenticating proximity, where a single packet is generated remotely, and transmitted from the server to the emitting device.

### DETAILED DESCRIPTION

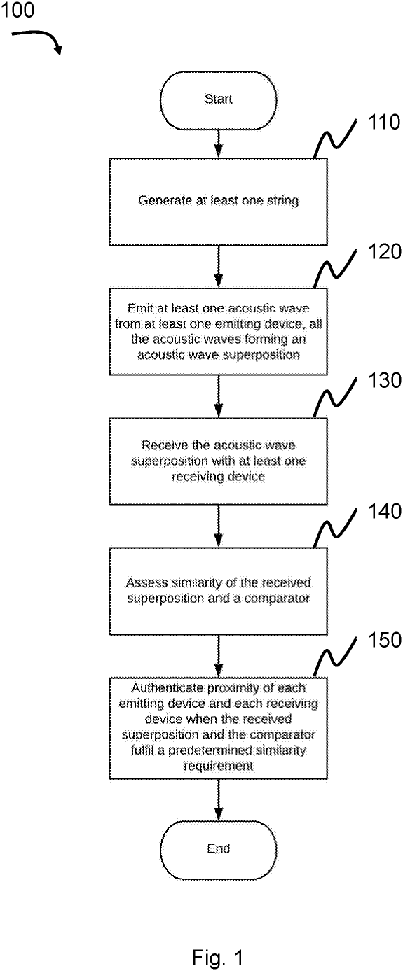

We have developed a process that allows for authenticating that two or more devices are in proximity, by which we mean they have similar locations. For example, two or more devices in proximity could be 30 cm, or 30 m away from each other, or they may be in the same room. It is therefore intended that there will be a physical separation between the two or more devices, such as requiring passage of sound through the air. Equally, devices could be separated by a medium other than air, such as a liquid, or any other medium that sound can travel through. This is achieved by a process, illustrated by reference 100 in FIG. 1.

FIG. 1 shows a flowchart for a method of proximity authentication according to an example.

At step 110, at least one packet is generated. A packet in this context refers to a virtual data structure used to store a series of characters representing an acoustic wave, which may be generated randomly or in a predictable way. The packet includes information which can be used by an emitting device to emit an acoustic wave.

The length or size of the packet can be variable. For example, a packet could comprise 140 characters, or some other number of characters, such as 300 characters. Any number of characters is possible. The size of a packet may correspond to the complexity of the acoustic wave which is generated from that packet. For example, a longer packet may produce a more complex acoustic wave than a shorter packet. Equally, in some examples, a shorter packet may correspond to a more complex acoustic wave than a longer acoustic wave, such as in examples where the packet includes a cryptographic function.

In some examples, the packet may be locally generated at an emitting device. In other examples, the packet may be generated remotely, for example at a server, and then transmitted to the emitting device. If the packet is generated remotely, then the emitting device and the server are each able to communication via a network to which they are each able to connect, such as a wireless network. In other words, the emitting device and the server form part of a network.

Regardless of the source of the packet, in various examples, the packet itself is able to include a cryptographic function, a .wav audio file, a sequence of characters, instructions or (executable) code, a waveform, or a pulse, such as a voltage pulse. Depending on what is included as part of the packet, how a respective emitting device turns this into an acoustic wave will differ. Generally speaking however, these will converted to from the form in which they are in a packet to an audio form since they will be in an electronic from initially.

The emitting device and the server do not always need to be actively connected to the network. Instead, the emitting device and the server are each respectively only connected to the network when there is a need to transmit a packet over the network between the server and emitting device. Indeed, in various examples, the packet is generated at one time and then stored, either at the server or at some other location in the network, before being transmitted at some later time to the emitting device following a request from the emitting device for a packet.

At step 120, at least one emitting device emits an acoustic wave corresponding to the generated packet. At least one acoustic wave is emitted per packet generated, and all the emitted acoustic waves combine to form an acoustic wave superposition.

In various examples, an emitting device emits an acoustic wave using a speaker. Other sound emitting devices can be used in other examples.

Each acoustic wave that is emitted is typically emitted in the ultrasound waveband, which can be considered to be from 15,000 Hz and above. Equally, the acoustic wave could be emitted in an audible range, or an infrasound range. All of the emitted acoustic waves are capable of forming an acoustic wave superposition.

The ambient noise in the immediate surroundings of the emitting device will be included as part of the superposition in addition to the acoustic waves, but in some examples this is removed at a later stage of the process.

The acoustic wave superposition is able to be formed of one, two, three or more emitted acoustic waves. When the superposition is formed of one (i.e. only a single) emitted acoustic wave the superposition corresponds to the emitted acoustic wave and ambient noise.

When the superposition is formed of more than one acoustic wave, these combine to form the superposition, since the acoustic wave may be different durations to each other, and/or respective emitted devices start to emit each respective acoustic wave at different times, the superposition can be expected not to be simply be a combination of all of the acoustic waves. Instead, in various examples the superposition is a combination of the acoustic waves having a duration lasting from the start of the first emitted acoustic wave to the end of the last emitted acoustic wave or the end of the last acoustic wave to be being emitted after any other acoustic waves have ended.

The acoustic wave superposition is received by at least one receiving device at step 130. Typically, the receiving device is the device that the emitting device wishes to authenticate proximity with. The receiving device typically uses a microphone to receive the acoustic wave superposition. Other sound receiving devices can be used in other examples.

In some examples, the receiving device is also an emitting device. For example, a smartphone could be used to emit and receive sounds within the same window of time. Smartphones are well known in the art and are not described in detail herein.

Once the acoustic wave superposition has been received, an assessment of the similarity of the received superposition to a comparator, which, in some examples, takes the form of an output from is a prediction as to what the expected superposition will be, is conducted at step 140. In some examples, the assessment is performed locally on each receiving device. In other examples, the assessment is performed remotely (i.e. not at the receiving device), for example at a server.

The comparator is not limited to being a prediction of the expected superposition. Alternatively, the comparator may be another criteria, which indicates, for example, that the superposition was created based on the contents of the generated packet. In this sense, a dedicated comparator is not constructed, but rather the instructions are repurposed as a comparator. For simplicity, in the examples discussed below, we only consider scenarios where the comparator is a prediction of the expected superposition or is a superposition itself received by another device.

In some examples, the assessment may be performed by comparing the dominant frequency in a certain waveband of the acoustic wave superposition with the dominant frequency of the comparator in the same waveband. The value of the amplitude for the dominant frequency could also be noted in each waveband, for both the acoustic wave superposition and the comparator. Dominant frequency and amplitude are just two examples of features which could be compared, but any number of spectral features could be compared between the acoustic wave superposition and the comparator.

Similarly to the emitting device, in examples where the assessment is performed remotely, the receiving device is able to communicate with a server where the assessment is to be carried out. In various examples this is achieved via a wired or wireless communication method. This communication is intended to be performed over the network to which the server and receiving device(s) are connectable in the manner described above for each emitting device and server. In examples where a server carries out the assessment according to step 140, this may be a different server from the server that generated the one or more packets if the packets were generated remotely from each emitting device.

As set out above, to be clear, the receiving device does not always need to the actively connected to the server, but rather in some examples is only connected when the need to perform authentication arises. In other words, in various examples the receiving device is only connected to the server while it needs to exchange data with it.

In some examples the comparator is a mathematically computed quantity which is expected to match the acoustic wave superposition. The comparator does not need to be formed by emitting any acoustic waves, but rather is typically computed mathematically. In some examples, where more than one device receives the acoustic wave superposition, the comparator is an acoustic wave superposition itself. In other words, in some case a plurality of acoustic wave superpositions received at different receiving devices are compared with each other.

Step 140 may also include additional processing to be performed on the acoustic wave superposition. For example, ambient sound in the acoustic wave superposition may be identified and removed at this stage.

At step 150, if the received acoustic wave superposition and the comparator fulfil a predetermined similarity requirement, proximity of each emitting device and each receiving device is authenticated. The predetermined similarity requirement provides a level of security and confidence in the authentication method. Usually, the comparator and received superposition are required to be 100% similar, i.e. identical, but this requirement may be lowered depending on the scenario. For example, in some examples a similarity of 90% may be sufficient. In various examples the receiving and emitting devices are informed of a positive authentication via a message or transmission sent to each of the receiving and emitting devices. This is usually sent by the device which assesses the similarity of the acoustic wave superposition and the comparator.

In this way, the proximity of at least two devices has been authenticated. Certain features of the process will be discussed in greater detail below.

To trigger the start of the authentication process, in some examples a user could interact with an emitting device or receiving device to manually begin the authentication process. In some examples, the emitting device is also a receiving device. In such examples, a microphone of the receiving device may be configured to activate at regular intervals to determine if any acoustic waves are receivable at the time the microphone is active. In effect the device is configured to monitor the sounds in its surroundings to determine if there is an opportunity to perform authentication. If it is determined that the device is receiving an acoustic wave then the microphone remains on and the authentication process ensues. If no acoustic wave is detected, then the microphone is switched back off for an interval. For example, the microphone may be activated every millisecond for 0.1 milliseconds before being switched back off and reactivated again 1 millisecond thereafter. In other examples, each receiving device may be triggered to listen by a user action or by some other means.

One advantage of the present authentication process is that it can be performed in a shorter span of time compared to methods of the prior art. Typically, the entire process can be completed within a 0.5 second duration. In some examples, the entire authentication process can be completed in as little as 0.25 seconds. How quickly the process is able to be completed is linked to the complexity of the acoustic wave superposition. The more complex the superposition is, the less time it takes for authentication to occur since a similarity match can be achieved with a shorter duration of the superposition having been assessed. Complexity of the acoustic wave superposition can be considered to increase by adding further layers, such as by adding further varying characteristics. Once no further layers can be added, complexity can be further increased by increasing the duration for which the acoustic wave is emitted.

In this some examples, the devices are able to communicate with a server, such as by being connectable to the server, for example using an LTE network, or a Wi-Fi network. A wired connection may also be utilised. A possible implementation of a wired connection Ethernet. However the devices connect to the network, access to the network may be provided by communications technology in the device and may be facilitated using an application on the device or a web browser through which a predetermined webpage is accessed.

In some examples, the received acoustic wave superposition is converted into a hashed representation (such as be applying a hash function) and is sent to the server by the at least one receiving device. While it would be possible to send a non-hashed version of the received superposition, typically a hashed representation or some other converted or encrypted form of the superposition will be sent instead of the superposition itself in order to enhance the security of the channel between the device to the server.

The assessment of the similarity of the acoustic wave superposition and comparator is performed in various examples remotely at a server, but other examples is performed locally at each receiving device. In either case, the acoustic wave superposition and the comparator should be located in the same place to achieve this.

One example of performing the assessment is to analyse the spectral composition of the received acoustic superposition, and compare the dominant amplitude registered in particular frequency bands with the dominant frequency in the same frequency band of the comparator. A number of other examples of performing the assessment are also possible, such as various pattern recognition or pattern matching processes.

The complex nature of the emitted acoustic waves is a notable advantage of the developed process. To expand on this, every acoustic wave possesses a certain set of characteristics, such as amplitude, frequency, phase and duration. At least amplitude, frequency and duration are intrinsic to acoustic waves in general, and may be referred to as primary characteristics.

In some examples the packet from which a given acoustic wave is generated can be created so that the acoustic wave has preconfigured characteristics. The preconfigured characteristics are also able to vary while an acoustic wave is being emitted. In this way, the primary characteristics of an acoustic can be considered to “slide” or “step” and can be combined individually or with each other. For example, the amplitude of an acoustic wave could vary while it is being emitted. As a further example, an acoustic wave could be transmitted with a range of different frequencies either sequentially or in parallel. The frequencies could vary continuously (such as in a continuous slide) or discretely (such as in steps). An example relating to duration, the length of time the acoustic wave is emitted for may be 0.25 s, 0.5 s or some other length. In relation to a combination of the primary characteristics, a packet can be configured to cause an acoustic wave to be emitted with varying amplitude and/or varying frequency throughout the length of time over which the acoustic wave is emitted. Additionally, the duration may be varied, such as by the acoustic wave being emitted with pulses of set or varying duration, each pulse having a preconfigured amplitude and/or frequency that can either be kept constant within or between pulses or varied within or between pulses. As can be seen from this, a large number of different combinations are possible with greater variation of the primary characteristics within the acoustic wave increasing the complexity.

Phase is mentioned above as a characteristic. By emitting two or more corresponding acoustic waves at different frequencies and by varying one or more frequencies, the phase of the wave that is produced is able to be varied. In some examples a packet is configured to cause an acoustic wave to be emitted with sound of a particular phase or a varying phase. This is able to be achieved without varying other characteristics of the wave as well as in examples, such as those set out in the previous paragraph where there are other variations.

In other examples, two acoustic waves or portions of an acoustic wave could be emitted at the same frequency from the same device, but with a constant “lead” or “lag”, thereby introducing a constant phase shift between two portions. This phase shift could be used by an assessment module to assist in determining the similarity between a generated packet and a comparator.

In this way, the complexity, i.e. the unpredictability of the wave is increased. The primary characteristics can be chosen randomly, for example by randomly selecting a value for each of the primary characteristics from a range of possible values. Increasing the complexity of an acoustic wave has security benefits in the sense that proximity authentication could not accidentally occur for devices in proximity which do not wish to authenticate with each other.

The primary characteristics can be manipulated in a variety of ways to produce a wide range of different features in an acoustic wave. For example, an acoustic wave could comprise amplitudes at multiple distinct frequencies at one time. In some examples, the change in frequency over time could be monitored and used when assessing the similarity of an acoustic wave superposition and a comparator. In some examples, the number of frequencies present in an acoustic wave superposition could be compared to the number of frequencies present in a comparator to assess the similarity of the acoustic wave superposition and the comparator. Any pattern or combination of the primary characteristics can be produced resulting in an acoustic wave with a unique and complex spectral composition.

In addition to primary characteristics, secondary characteristics, such as a time stamp for when the acoustic wave was emitted, a geostamp detailing the Global Positioning System (GPS) coordinates of the emitting device, the Wi-Fi network which the emitting device is or could be connected to, if any can be added to an acoustic wave when it is received at a receiving device. The time stamp does not necessarily need to reflect the time at which the acoustic wave was emitted, although it can be used for this purpose; rather, it could also indicate the time at which a characteristic of the acoustic wave varies. Equally, a timestamp could be used to indicate a number of different features of an acoustic wave.

The timestamp can be used to identify the acoustic wave if other characteristics of the acoustic wave are compromised. For example, if the device is moving while authentication is being performed, this can lead to the Doppler effect changing features of the acoustic wave, and authentication being rejected. The repercussions of the Doppler effect can be avoided by using the timestamp to identify the acoustic wave based on the time is was emitted and the time that a characteristic of the wave varies.

Another example of a secondary characteristic is a complexity rating for the acoustic wave superposition, which may have particular benefits in examples where the acoustic wave superposition is assessed in a hashed format.

These secondary characteristics can be thought of as metadata. Many items of metadata can be included in an acoustic wave after it has been received, and they each create additional complexity in the received acoustic wave. Further examples of metadata include the clock speed of a device’s CPU, the operating system of the device, a specific interaction of the user with the device, such as a swipe or gesture on a touchscreen or a unique device identifier. Any or all of these items of metadata may be added to the acoustic wave superposition. As with the preconfigured primary characteristics, any pattern or combination of secondary characteristics may be included in the received acoustic wave superposition. The received acoustic wave is of course the received acoustic wave superposition.

Additional examples of secondary characteristics are the ambient sound included in the acoustic wave superposition. The interference of ambient sound with an acoustic wave can create additional complexity in the acoustic wave superposition in a predictable way. The acoustic wave can also interfere with, or be modulated by another signal. The interference could be constructive or destructive, and can occur in a predictable or random way. The unique way in which the interference occurs can be used as an identifier. Further, when a smartphone device, or any device having a digital camera is used, the camera may be activated during the process to provide additional information, such as the location of the device, or could be used to scan a distinctive image in the vicinity of the user, a representation of which could be included in the acoustic wave superposition. The distinctive image could be a photograph, for example. Alternatively, the distinctive image could a light source with known and configurable characteristics. Any of the secondary or primary characteristics can be used in combination with each other to bolster the complexity and randomness of the acoustic wave superposition. The secondary characteristics can be added or applied to the acoustic wave superposition after it has been formed.

One further example of a secondary characteristic is a slide identifier. Note that this is not the same as the “slide” characteristic mentioned above in relation to the variation of primary characteristics while an acoustic wave is emitted. A slide identifier notes the direction in which a primary characteristic has changed. For example, during the emission of an acoustic wave, the frequency of the wave slides up from 16,000 Hz to 17,000 Hz. Then, a slide identifier will record that the frequency slid “up”. Conversely, when the frequency of an acoustic wave is reduced during emission, a slide identifier will record that the frequency slid “down”. A slide identifier can be used to record the direction of change for any of the primary characteristics, and adds an additional layer of complexity to the acoustic wave superposition.

In various examples some or all of the metadata is used in the hashing operation or as salt as part of the hashing process. As mentioned above, hashing is an optional feature which improves the security of the authentication process. In examples where hashing is used, the acoustic wave superpositions are assessed in the hashed format, unless an un-hashing process is carried out to recover the original acoustic wave superpositions. When a hashed acoustic wave superposition is compared to a comparator, the complexity rating of the superposition can be used to determine if the acoustic wave superposition fulfils the similarity requirement with the comparator without the need to un-hash the acoustic wave superposition.

To improve the security of the authentication method, in some examples, one feature that can be used is to alter the received superposition so that certain characteristics of the wave are obscured during assessment or removed before assessment. For example, the amplitude of the acoustic wave superposition in a particular frequency band could be suppressed or removed so that it cannot be read during assessment. If, during assessment, an acoustic superposition with a readable amplitude in the suppressed frequency band is presented, authentication of that acoustic superposition is automatically rejected since it is immediately apparent that the superposition being authenticated is not the superposition that is expected.

In other examples, another way to bolster the security of the authentication method is for the receiving device to also emit an obfuscating acoustic wave that contributes to the acoustic superposition. When the acoustic superposition is received at the receiving device, the component of the acoustic superposition arising from the obfuscating wave may be removed. This is particularly useful in situations where a third-party device is fraudulently attempting to authenticate proximity.

In examples where the obfuscating wave is removed from the acoustic wave superposition, the third-party device would receive the acoustic superposition with the obfuscating wave, but not be aware that the obfuscating component is expected to be removed before assessment. If the third-party device presents an acoustic superposition with the obfuscating component during assessment, authentication of that acoustic wave superposition is automatically rejected.

In some examples, the obfuscating wave is not removed from the acoustic wave superposition, but the assessment module is aware of the components of the acoustic wave superposition that arise from the obfuscating wave. The assessment module would then be able to determine any discrepancies between the presented acoustic wave superpositions and the comparator, and accordingly reject authentication of the devices.

For example, the obfuscating wave could include one or more frequencies at a played at a particular amplitude. The amplitude will diminish as the distance from the source increases. As such, when the an assessment is carried out on the superposition received by the receiving device issuing the obfuscating wave, the characteristics of the received superposition will include the correct amplitude for at the one or more frequencies (whether this is separate to the amplitude of the frequencies in the received superposition provided by the acoustic wave(s), or complimentary to the amplitude of those frequencies). This will allow that authentication of that receiving device to be approved. In contrast, when a received superposition is submitted for assessment by a third-party device, since the distance from the source of the obfuscating wave will be different, the amplitude of the one or more frequencies will be reduced, and therefore not be correct. This will be identified as part of the authentication process, and authentication of the third-party device would then be rejected.

To further improve the security of the authentication, and prevent an eavesdropping party from recording and replaying an acoustic wave superposition, in some examples, the packet may include information that leads to characteristics of the generated acoustic wave changing based on the time the packet was generated. In this way, an acoustic wave superposition formed of the generated acoustic waves can become invalid after a certain time, such as a few seconds. This means that any recorded acoustic wave superposition would not be valid at the time of replaying.

Another way that the characteristics of the acoustic wave may be influenced based on time is to vary their characteristics based on the time that they are emitted within a certain time-period. For example, acoustic waves emitted on a given day of the week, or a given minute within an hour, and so on, will have particular characteristics.

Yet another way that the characteristics of a wave may be influenced based on time is to emit an acoustic wave at a particular point within a given time frame. For example, a device may only emit an acoustic wave at the beginning of every second, but another device may only emit an acoustic wave at 30 milliseconds after the start of a second.

In some examples where proximity of two or more device is positively authenticated, the device which performs the assessment typically notifies the devices wishing to authenticate of successful authentication by transmitting a token to the devices. Once received by the devices wishing to authenticate, the token indicates to the devices that authentication has been successful.

In the present context, a token is associated with a sound to act as an identifier for the sound. In some examples, a token may be reused when it is no longer needed for the sound it was previously allocated to.

A sound is a realisation of the characteristics of the acoustic wave, which as discussed above, are designed to be as unpredictable as possible. By use of a token, since this is associated with a sound, a device being used to emit an acoustic wave, or used to receive an acoustic wave superposition, a token can be used to track which devices the sound was passed through.

The foregoing discussion explores different features of the present process. Below, we will describe examples of specific use-cases of the proximity authentication method. The use-cases may be applicable in a number of real-world scenarios, such as when entering the reception area of a building to confirm a user’s identity, when making a payment using a device such as a smartphone, when collecting pre-purchased items from a designated location or when tracking and tracing the contacts of a user.

As an example of how the process of checking into a building reception may be applied, this is expanded on here. A user may enter a building and arrive at a reception desk. At the reception desk, there is a station which includes an emitting device which is constantly, or intermittently emitting an acoustic wave. The user may be directed to the station, where they would activate the authentication process on their device. Depending on the volume the emitting device is emitting the acoustic wave at the user may also be able to activate the authentication process on entry to the building since a “sonic sphere” will be created by the emitting device. Whichever approach is taken, at this point, the user’s device could emit an acoustic wave based on a packet, or the user’s device could act as a receiving device and form an acoustic wave superposition comprising the acoustic wave being emitted at the station. This acoustic wave superposition can be assessed against a comparator, and the station can subsequently by notified, such as via a token, that the user has arrived at the building. In some examples the token could contain information which identifies the user’s device.

Authentication in any of the aforementioned use-cases may be implemented using one or more Application Programming Interface (API). An API may be designed so that one emitting device emits an acoustic waves based on a unique packet, which is then received by one listening device. Such an API possesses the advantage of facilitating fast and secure authentication, which may be beneficial in a contactless payment scenario. Another example of an API which could be used to implement authentication involves an emitting device which emits an acoustic wave on a loop. A receiving device then receives the acoustic wave as an acoustic wave superposition which can then be assessed to establish authentication. As an example, this API would be useful in use-cases where visitors check into the reception of a building. Another example of an API which could be used to implement any of the above use-cases requires that each device is an emitting and receiving device and, through establishing authentication, allows for a connection to be created between the at least two devices.

Of course, the above examples of APIs are not the only ways to implement authentication. Other APIs are possible.

Below, implementations are discussed which will provide specific details of the authentication process with reference to the drawings.

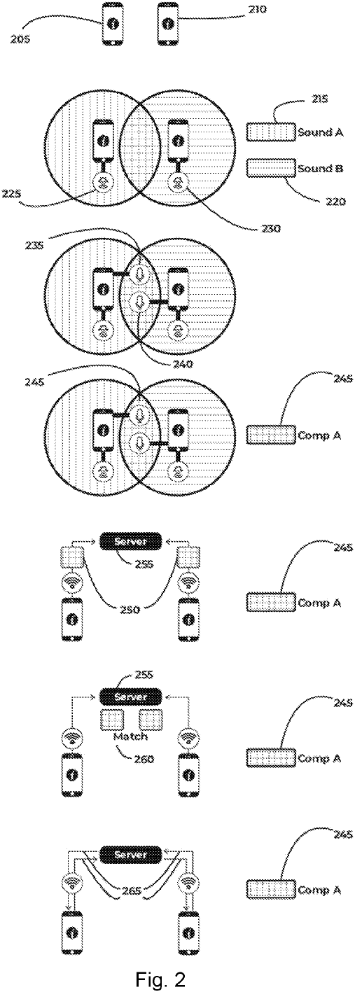

In some examples, each emitting device is also a receiving device, and each receiving device is also an emitting device. FIG. 2 illustrates one such example.

In the example shown in FIG. 2, users of a first device 205 and a second device 210 wish to authenticate proximity. To achieve this the first device 205 generates a first packet 215, while the second device 210 generates a second packet 220. This is an example of packets being generated locally.

Each of the first and second devices then emit an acoustic wave, which respectively corresponds to the first and second packets. To be explicit, first device 205 emits a first acoustic wave 225 based on the first packet 215. While the first acoustic wave 225 is being emitted, the second device 210 emits a second acoustic wave 230, based on the second packet 220.

When the first acoustic wave 225 and second acoustic wave 230 are being emitted, the first device 205 and the second device 210 also listen to the emitted acoustic waves. In some examples each device is triggered to start listening when it starts emitting the respective acoustic wave. In other examples, each device is either continuously listening or is caused to listen by some other event, such as when an application is opened or run on the respective device or when a user selects a listening option.

The received first and second acoustic waves once emitted form an acoustic wave superposition 245. The first device 205 then receives the first acoustic wave 225 and the second acoustic wave 230 as the acoustic wave superposition 245. Similarly, the second device 210 also receives the first acoustic wave 225 and the second acoustic wave 230 as the acoustic wave superposition 245.

In this particular example, the devices can connect to a server 255, for example using a wireless network. The formed acoustic wave superposition 245 is wirelessly sent 250 to the server 255 by the first device 205 and the second device 210. Once received at the server, the server 255 assesses the acoustic wave superposition 245 received from the first device 205 to the acoustic wave superposition received from the second device 210.

In this example and others, the acoustic wave superposition may be converted to a hashed format and be assessed in a hashed format, but typically an un-hashed format may also be used. If a hashed format is used, then the comparator used in the assessment would typically also be the superposition received at a different location that has also been hashed. This is because only then will the first hashed superposition be capable of matching (and therefore meeting a similarity threshold) the comparator in order for authentication to occur without an un-hashing operation being conducted before the assessment is carried out. If this process is not carried out in this manner, it will not be possible for the hashed superposition to match a comparator because typically only identical superpositions would result in a matching hash.

It is worth noting, that, in this example, the comparator is the acoustic wave superposition 245 itself. In essence, in this example, the server compares two copies of the acoustic wave superposition 245, as received at the first device 205 and the second device 210 to determine their similarity.

If the server 255 determines that the acoustic wave superposition 245 received from the first device 205 is similar 260 to the acoustic wave superposition 245 received from the second device 210, then the proximity of the first device 205 and the second device 210 is authenticated, as shown in FIG. 2 by the lines 265 which connect the first device 205 and the second device 210 via the server 255.

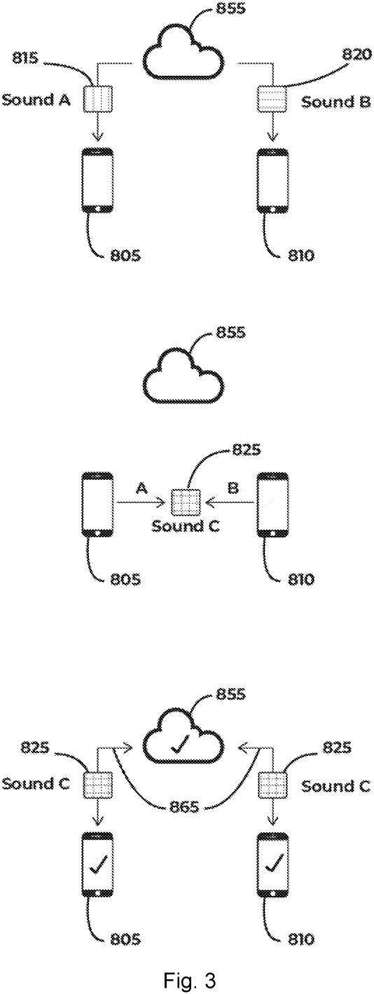

FIG. 3 shows a similar process to FIG. 2, except that in FIG. 3, the first device 805 and the second device 810 each receive a packet which is remotely generated at a server 855. The first device 805 receives a first packet 815, and the second device 810 receives a second packet 820. The first packet 815 and the second packet 820 combine to form an acoustic wave superposition 825. The received acoustic wave superposition 825 is transmitted to the server 855 by each of the first device and second device. In this example, since the server 855 generated both of the first packet 815 and the second packet 820, the server is able to combine them to form a comparator. Alternatively, the server is able to compare the received superposition sent to it from the first device with the received superposition sent to it from the second device. When the acoustic wave superpositions 825 are determined to fulfil the similarity requirements, the first device 805 and the second device 810 are authenticated, as indicated by lines 865 extending between the server to each of the first device 805 and the second device 810.

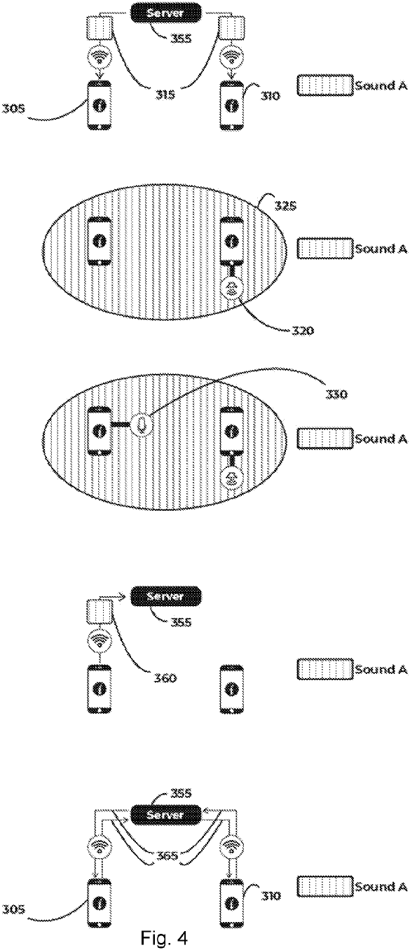

FIG. 4 illustrates an example where a packet is remotely generated at a server, then transmitted to two devices wishing to authenticate. In some examples similar to that shown in FIG. 4, the packet is instead locally generated at the second device 310.

In the example shown in FIG. 4, the packet 315 is generated at the server 355 and then transmitted to both of the first device 305 and the second device 310. The second device emits a first acoustic wave 320, based on the packet 315. The acoustic wave can be received in an area 325. This can be thought of as the proximity in which receiving devices can be authenticated as well as the perimeter within which the first acoustic wave is audible by another device.

While the first acoustic wave 320 is being emitted, the first device 305 activates a microphone to receive 330 the first acoustic wave 320 as an acoustic wave superposition 360. The first device 305 subsequently receives the acoustic wave superposition. In this case, the acoustic wave superposition 360 comprises the first packet together with any ambient noise.

The received acoustic wave superposition 360 is then transmitted to the server via a wireless connection. Once received by the server 355 this assesses the similarity of the acoustic superposition 360 and a comparator. In this example, since the server generated the first packet, the server 355 is aware that it is expecting an acoustic wave superposition which comprises the first packet 315. As such, in this example the first packet 315 is also the comparator. Equally, in variations on this example the assessment is carried out locally at the first device 305, since the first device 305 also received the first packet 305. In examples where the first device does not carry out the assessment, the first device does not need to be provided with the packet 315.

When it is determined that the acoustic wave superposition and the comparator fulfil the predetermined similarity threshold, proximity of the first device 305 and the second device 310 is authenticated. A message is then communicated to the first device 305 and the second device 310 informing of positive proximity authentication, as shown by lines 365 extended between the first device and the second device via the server 355. In other examples, the authentication is confirmed to the devices in other manners.

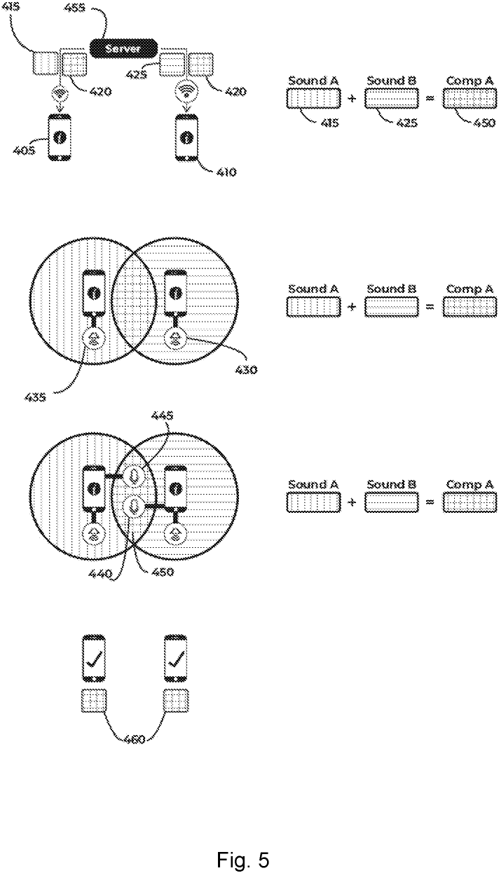

It is possible to envisage a situation where the users of each of two or more devices may wish to authenticate proximity in an environment where they are unable, or do not wish, to connect, via a network, to a server at the time of authentication. FIG. 5 illustrates such an example.

In FIG. 5, at a time before the first device 405 and the second device 410 wish to authenticate, a packet and a comparator are sent to each device from a server 455. To be specific, in this example, the first device 405 receives a first packet 415 and a comparator 420, and the second device receives a second packet 425 and the comparator 420. The first packet 415 and the second packet 425 are chosen in such a way that they are able to combine to produce the comparator 420. This means that in this example, each device is given a different part of the comparator, as well as the complete comparator.

As an example of a specific implementation of how the first device 405 and the second device 410 receive part of a comparator, a comparator is able to be considered to be a comparator that has a duration of 1 second, and comprises and acoustic wave with amplitudes between 16,000 Hz and 17,000 Hz, at 100 Hz intervals. In other words the comparator exhibits amplitudes at 16,000 Hz, 16,100 Hz, 16,200 Hz and so on up to 17,000 Hz. In this case, the first packet 415 could be configured to cause a first acoustic wave 435 to be emitted with amplitudes from 16,000 to 16,500 Hz, at 100 Hz intervals. The second packet 425 could be configured to cause a second acoustic wave 430 to be emitted with amplitudes from 16,600 Hz to 17,000 Hz at 100 Hz intervals. An acoustic wave superposition formed of the first acoustic wave and the second acoustic wave will therefore have amplitudes from 16,000 Hz to 17,000 Hz at 100 Hz intervals, which is identical to the comparator.

Returning to the example depicted in FIG. 5, at a later time, when the first device 405 and the second device 410 wish to authenticate in an offline environment, the first device 405 emits a first acoustic wave 435 corresponding to on the first packet 415. While the first acoustic wave 435 is being emitted, the second device 430 also emits a second acoustic wave 430 based on the second packet 425.

A microphone of the first device 405 is also activated to receive the first acoustic wave 435 and the second acoustic wave 430. Similarly, a microphone of the second acoustic device 410 is activated to receive the first acoustic wave 345 and the second acoustic wave 430. Each of the first device 405 and the second device 410, receive the first acoustic wave 435 and the second acoustic wave 430 combined in the form of an acoustic wave superposition 450. Subsequently, the acoustic wave superposition 450 is compared to the comparator 420, which is stored locally on each of the first device 405 and the second device 410. If the first device 405 and second device 410 determine that the received acoustic wave superposition 450 is similar to the comparator 420, then proximity of the first device 405 and the second device 410 is authenticated 460 by each device separately.

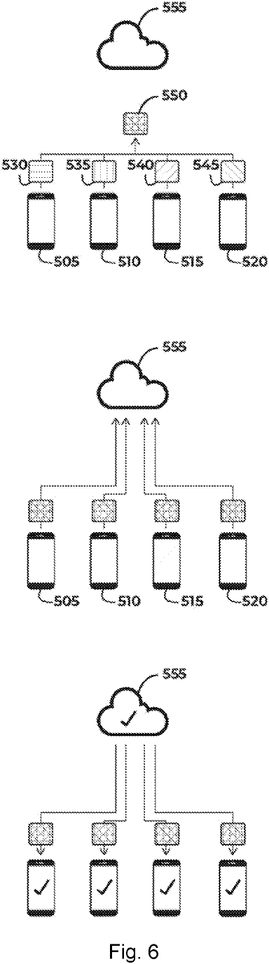

The example are not limited to only being able to authenticate the proximity of two devices. The authentication process described above may be used to authenticate proximity of any number of devices, such as three, four or five devices. The process described above is easily scalable to allow proximity of more devices to be authenticated. FIG. 6 illustrates an example where the proximity of four devices is authenticated.

In the example shown in FIG. 6, users of each of a first device 505, a second device 510, a third device 515 and a fourth device 520 wish to authenticate proximity. All four devices are connectable to a server 555 in this example.

Each device in FIG. 6 generates an acoustic wave based on a packet. The packets are generated locally in the example shown in FIG. 6. In an alternative example the packets are each generated remotely by the server 555.

In the example in FIG. 6, the first device 505 emits a first acoustic wave based on a first packet 530, the second device emits second acoustic wave based on a second packet 535, the third device 515 emits a third acoustic wave based on a third packet 540 and the fourth device emits a fourth acoustic wave based on a fourth packet 545. Each of the four devices in FIG. 6 is an emitting device and a receiving device. Thus, each of the four devices emits an acoustic wave, creating a total of four acoustic waves. The four acoustic waves form an acoustic wave superposition 550, and each of the four devices receives the combined four acoustic waves as the superposition.

The received acoustic wave superposition 550 is converted to a hashed representation and transmitted to the server 555 by each of the four devices. This results in the server 555 receiving four copies of the acoustic wave superposition 550, one from each of the four devices. The server 555 then compares the copy of the received acoustic wave superposition 550 from each device to the received acoustic superposition 550 received from every other device to establish which devices are in proximity. In this scenario, the comparator is an acoustic wave superposition.

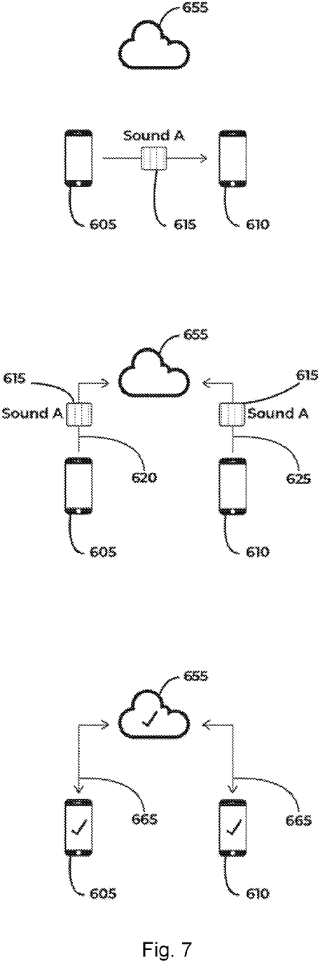

FIG. 7 depicts an example which is similar to that of FIGS. 2 and 4. In FIG. 7, a first device 605 and a second device 610 wish to authenticate. A first packet 615 is generated locally on the first device 605 and an acoustic wave is emitted based on the first packet 615. The emitted acoustic wave is received by the second device 610 in the form of an acoustic wave superposition. The first device 605 transmits the first packet 615 to the server 655. In this example, the first packet 615 is able to provide the comparator. Concurrently, the second device 610 transmits the acoustic wave superposition 625 to the server 655. If the comparator and acoustic wave superposition 625 are determined to fulfil the similarity requirement, then the devices are authenticated.

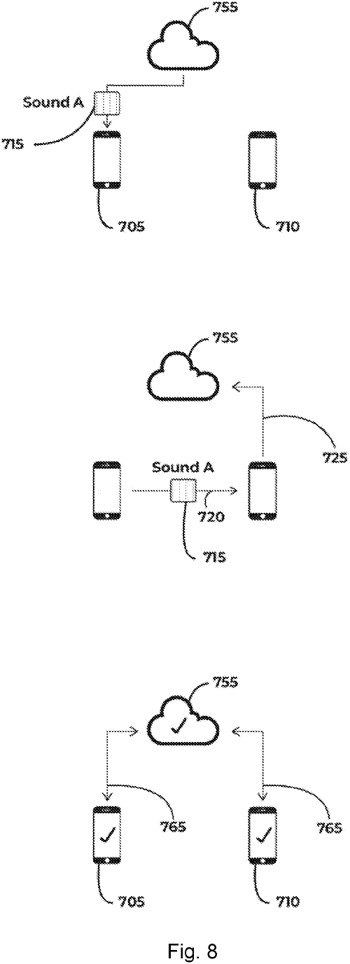

FIG. 8 illustrates an example similar to FIG. 4 except only the first device 705 is provided with the first packet 715 by the server 755. The second device 710 then receives, in the form of an acoustic wave superposition, an acoustic wave which is generated by the first device 705 based on the first packet 715.The received acoustic wave superposition is sent 725 to the server 755. As with other examples, the devices are authenticated subject to the comparator, which in this example, is the first packet 715 and the acoustic wave superposition satisfying similarity requirements. This example is also similar to the example shown in FIG. 7 and only differs by where the first packet is generated, and thereby whether the first packet is transferred to the server or is already located at the server when the authentication assessment is to be carried out.

Another implementation of the present method is now described. This implementation is not specifically shown in the figures, but provides specific implementations of the examples shown in FIGS. 2, 3 and 5. In various examples of this implementation, a first device emits a first acoustic wave based on a first packet. The first acoustic wave may be emitted in discrete pulses or in a continuous loop. As with previous examples, the packet may be generated by the first device or by a remote server.

While the emitting the first acoustic wave, the first device also receives the first acoustic wave. When a second device, which wishes to authenticate with the first device is in proximity to the first device, the second device also emits a second acoustic wave that includes the same frequency as at least one frequency in the first acoustic wave, with the same or different amplitude as the first acoustic wave.

The proximity of the first device and the second device results in an interference pattern being formed by the first and second acoustic waves. This interference pattern may be received by one or both of the first device and the second device. The nature of the interference depends on a number of factors, including the frequencies and amplitudes of the first acoustic wave and the second acoustic wave, as well as the distance between the first device and the second device.

In this example, the interference pattern forms the acoustic wave superposition. When the acoustic wave superposition is received by both devices, both device may send the received acoustic wave superposition to a server. The server may then compare the received acoustic wave superpositions to determine if the interference patterns recorded by both devices are similar or identical. In this sense, the interference pattern forms both the acoustic wave superposition and the comparator. Based on a threshold similarity requirement, authentication between the two devices may be established.

In some examples, the first device may receive information which corresponds to an interference pattern expected to be recorded if a second device emits an acoustic wave with a certain set of characteristics. In this case, the expected interference pattern is the comparator. The first device could then emit a first acoustic wave based on a first packet, and the second device could emit a second acoustic wave based on a second packet, such that the resulting interference pattern between the first and second acoustic wave forms the interference pattern expected by the first device. When the first device determines that the expected interference pattern has been recorded, authentication between the devices is established.

As an example of the above scenario, a first device may receive information that the expected interference pattern is a wave emitted at a frequency of 1500 Hz with an amplitude of 15 dB. The first device then emits an acoustic wave with a frequency of 1500 Hz, with an amplitude of 10 dB. A second device which emits a second acoustic wave with a frequency of 1500 Hz, at an amplitude of 5 dB would result in the first device recording an interference pattern of 1500 Hz at 15 dB, which is the expected interference pattern. Note that the physically received interference pattern is the acoustic wave superposition, while the information received about the expected interference pattern is the comparator. The above is only an example of the present scenario, and other expected interference patterns are possible.

To be clear, in each of the foregoing examples where the formed acoustic superposition is transmitted to a server, the acoustic wave superposition is typically transmitted in a hashed representation.

1. A method for authenticating the proximity of at least two devices, the method comprising:
generating at least one packet;
emitting at least one acoustic wave from at least one emitting device, each acoustic wave corresponding to a generated packet, at least one acoustic wave being emitted for all the generated packets, all the emitted acoustic waves forming an acoustic wave superposition;
receiving, with at least one receiving device, the superposition;
assessing the similarity of the received superposition and a comparator; and
authenticating proximity of each emitting device and each receiving device when the received superposition and the comparator fulfil a predetermined similarity requirement, wherein the comparator corresponds to a combination of all the generated packets.

2. The -method according to claim 1, wherein each emitting device and each receiving device being connectable to a network, each emitting device and each receiving device thereby being part of the network.

3. The method according to claim 2, wherein each generated packet is generated in the network.

4. The method according to claim 2, wherein the received superposition and/or comparator are transmitted within the network to an assessment module from a respective source.

5. The method according to claim 1, wherein when the assessment module determines that the superposition and the comparator do not fulfil a threshold similarity requirement, the assessment module does not authenticate proximity of the at least one emitting device to the at least one receiving device.

6. The method according to claim 1, wherein each emitted acoustic wave includes at least one configured primary characteristic, the configured primary characteristic being determined by the packet to which the respective acoustic wave corresponds.

7. The method according to claim 6, wherein the configured primary characteristic comprises at least one of: frequency, amplitude and duration, and
wherein each configured primary characteristic is variable during emission of the respective acoustic wave.

8. (canceled)

9. The method according to claim 1, wherein each received superposition has at least one configured secondary characteristic, and
wherein the configured secondary characteristic comprises at least one of: a complexity rating, a timestamp, a geostamp, ambient sound.

10. (canceled)

11. The method according to claim 1, wherein, the received superposition has at least one primary characteristic, the primary characteristic comprising at least one of frequency, amplitude and duration, and before the received superposition is assessed, the received superposition is altered to remove at least one property of at least one primary characteristic.

12. The method according to claim 11, wherein each acoustic wave emitted from an emitting device is a first acoustic wave, the method further comprising:
emitting, by a receiving device, a second acoustic wave concurrently with each first acoustic wave, wherein all the first acoustic waves and second acoustic waves form the acoustic wave superposition; and
removing each second acoustic wave from the received superposition before the received superposition is assessed.

13. The method according to claim 1, wherein the predetermined similarity requirement is 100%.

14. The method according to claim 1, wherein the minimum frequency of each acoustic wave is 15 kHz.

15. The method according to claim 1, wherein the maximum frequency of each acoustic wave is 25 kHz.

16. The method according to claim 1, wherein only a single packet is generated, and
wherein there is only a single emitting device, and the single packet is generated at the single emitting device.

17. The method according to claim 1, wherein a plurality of packets are generated, and
wherein there are a plurality of emitting devices, each emitting device generating at least one of the packets and emitting the packets generated at the respective device as acoustic waves.

18. (canceled)

19. (canceled)

20. The method according to claim 1, wherein the at least one packet is generated remotely from each emitting device.

21. The method according to claim 1, wherein the assessment and authentication is carried out at each receiving device; or
wherein the assessment and authentication is carried out remotely from each receiving device.

22. (canceled)

23. The method according to claim 1, wherein there are a plurality of receiving devices, and at least one receiving device is also an emitting device.

24. The method according to claim 23, wherein at least one of the at least one of the emitting devices is also a receiving device.

25. The method according to claim 23, wherein the comparator is an acoustic wave superposition.
